(19) United States
(12) Patent Application Publication
(10) Pub. No.: US 2020/0090030 A1
(43) Pub. Date: Mar. 19, 2020

(54) INTEGRATED CIRCUIT FOR CONVOLUTION CALCULATION IN DEEP NEURAL NETWORK AND METHOD THEREOF

(71) Applicant: British Cayman Islands Intelligo Technology Inc., Grand Cayman (KY)

(72) Inventors: Shen-Jui HUANG, Zhubei City (TW); Meng-Hsun WEN, Zhubei City (TW); Yu-Pao TSAI, Zhubei City (TW); Hsuan-Yi HOU, Zhubei City (TW); Ching-Hao YU, Zhubei City (TW); Wei-Hsiang TSENG, Zhubei City (TW); Chi-Wei PENG, Zhubei City (TW); Hong-Ching CHEN, Zhubei City (TW); Tsung-Liang CHEN, Zhubei City (TW)

(21) Appl. No.: 16/573,032

(22) Filed: Sep. 17, 2019

Related U.S. Application Data
(60) Provisional application No. 62/733,083, filed on Sep. 19, 2018.

(51) Int. Cl. G06N 3/063; G06N 3/04

(52) U.S. Cl. CPC G06N 3/063; G06N 3/04

(57) ABSTRACT

An integrated circuit applied in a deep neural network is disclosed. The integrated circuit comprises at least one processor, a first internal memory, a second internal memory, at least one MAC circuit, a compressor and a decompressor. The processor performs a cuboid convolution over decompression data for each cuboid of an input image fed to any one of multiple convolution layers. The MAC circuit performs multiplication and accumulation operations associated with the cuboid convolution to output a convoluted cuboid. The compressor compresses the convoluted cuboid into one compressed segment and store it in the second internal memory. The decompressor decompresses data from the second internal memory segment by segment to store the decompression data in the first internal memory. The input image is horizontally divided into multiple cuboids with an overlap of at least one row for each channel between any two adjacent cuboids.

### CROSS-REFERENCE TO RELATED APPLICATION

This application claims priority under 35 USC 119(e) to U.S. provisional application No. 62/733,083, filed on Sep. 19, 2018, the content of which is incorporated herein by reference in its entirety.

### BACKGROUND OF THE INVENTION

### Field of the Invention

The invention relates to deep neural network (DNN), and more particularly, to a method and an integrated circuit for convolution calculation in deep neural network, in order to achieve high energy efficiency and low area complexity.

### Description of the Related Art

Deep neural network is a neural network with a certain level of complexity, a neural network with more than two layers. DNNs use sophisticated mathematical modeling to process data in complex ways. Recently, there is escalating trend to deploy the DNNs on mobile or wearable devices, the so-called Al-on-the-edge or Al-on-the-sensor, for versatile real-time applications, such as automatic speech recognition, objects detection, feature extraction, etc. MobileNet, an efficient network aimed for mobile and embedded vision application, achieves significant reduction in convolution loading by using combined depthwise convolutions and large amount of 1*1*M pointwise convolution when compared to the network performing normal/regular convolutions with the same depth. This results in light weight deep neural networks. However, the massive data movements to/from external DRAM still cause huge power consumption when realizing MobileNet, because the power consumption is 640 pico-Joules (pJ) per 32-bit DRAM read, which is much higher than that of MAC operations (ex. 3.1 pJ for 32-bit multiplications).

SOCs (system on chip) generally integrate a lot of functions, and thus are space and power consuming. Considering limited battery power and space on edge/mobile devices, a power-efficient and memory-space-efficient integrated circuit as well as method for convolution calculation in DNN are indispensable.

### SUMMARY OF THE INVENTION

In view of the above-mentioned problems, an object of the invention is to provide an integrated circuit applied in a deep neural network, in order to reduce the size and the power consumption of the integrated circuit and to eliminate the use of external DRAM.

One embodiment of the invention provides an integrated circuit applied in a deep neural network. The integrated circuit comprises at least one processor, a first internal memory, a second internal memory, at least one MAC circuit, a compressor and a decompressor. The at least one processor is configured to perform a cuboid convolution over decompression data for each cuboid of a first input image fed to any one of multiple convolution layers. The first internal memory is coupled to the at least one processor. The at least one MAC circuit is coupled to the at least one processor and the first internal memory and configured to perform multiplication and accumulation operations associated with the cuboid convolution to output a convoluted cuboid. The second internal memory is used to store multiple compressed segments only. The compressor coupled to the at least one processor, the at least one MAC circuit and the first and the second internal memories is configured to compress the first convoluted cuboid into one compressed segment and store it in the second internal memory. The decompressor coupled to the at least one processor, the first internal memory and the second internal memory is configured to decompress data from the second internal memory on a compressed segment by compressed segment basis to store the decompression data in the first internal memory. The input image is horizontally divided into multiple cuboids with an overlap of at least one row for each channel between any two adjacent cuboids. The cuboid convolution comprises a depthwise convolution followed by a pointwise convolution.

Another embodiment of the invention provides a method applied in an integrated circuit for use in a deep neural network. The integrated circuit comprises a first internal memory and a second internal memory, The method comprises: (a) decompressing a first compressed segment associated with a current cuboid of a first input image and outputted from the first internal memory to store decompressed data in the second internal memory; (b) performing cuboid convolution over the decompressed data to generate a 3D pointwise output array; (c) compressing the 3D pointwise output array into a second compressed segment to store it in the first internal memory; (d) repeating steps (a) to (c) until all the cuboids associated with a target convolution layer are processed; and, (e) repeating steps (a) to (d) until all of multiple convolution layers are completed. The input image is fed to any one of the convolution layers and horizontally divided into multiple cuboids with an overlap of at least one row for each channel between any two adjacent cuboids. The cuboid convolution comprises a depthwise convolution followed by a pointwise convolution.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a block diagram showing an integrated circuit for convolution calculation according to an embodiment of the invention.

FIG. 1B is a block diagram showing a neural function unit according to an embodiment of the invention.

FIG. 2 is a flow chart showing a method for convolution calculation according to an embodiment of the invention.

FIG. 3A is an example of an output feature map with a dimension of D_{F}*D_{F}*M for layer 1 in MobileNet.

FIG. 3B is an example showing the depthwise convolution operation of the invention.

FIG. 3C is an example showing the pointwise convolution operation of the invention.

FIG. 4A is a flow chart showing a row repetitive value compression (RRVC) scheme according to an embodiment of the invention.

FIGS. 4B and 4C depict flow charts showing a row repetitive value (RRV) decompression scheme according to an embodiment of the invention.

FIG. 5A is an example showing how the RRVC scheme works.

FIG. 5B is an example showing how the RRV decompression scheme works.

### DETAILED DESCRIPTION OF THE INVENTION

As used herein and in the claims, the term “and/or” includes any and all combinations of one or more of the associated listed items. The use of the terms “a” and “an” and “the” and similar referents in the context of describing the invention are to be construed to cover both the singular and the plural, unless otherwise indicated herein or clearly contradicted by context.

In deep learning, a convolutional neural network (CNN) is a class of deep neural networks, most commonly applied to analyzing visual imagery. In general, a CNN has three types of layers: convolutional layer, pooling layer and fully connected layer. The CNN usually includes multiple convolutional layers. For each convolutional layer, there are multiple filters (or kernels) used to convolute over an input image to obtain an output feature map. The depths (or the numbers of channels) of the input image and one filter are the same. The depth (or the number of channels) of the output feature map is equal to the number of the filters. Each filter may have the same (or different) width and height, which are less than or equal to the width and height of the input image.

A feature of the invention is to horizontally split an output feature map for each convolutional layer into multiple cuboids of the same dimension, sequentially compress the data for each cuboid into an individual compressed segment and store the compressed segments in a first internal memory (e.g. ZRAM 115) of an integrated circuit for a mobile/edge device. Another feature of the invention is to fetch the compressed segments from the first internal memory on a compressed segment by compressed segment basis for each convolution layer, de-compress one compressed segment into decompressed data in a second internal memory (e.g. HRAM 120), perform cuboid convolution over the decompressed data to produce a 3D pointwise output array, compress the 3D pointwise output array into an updated compressed segment and store the updated compressed segments back to the ZRAM 115. Accordingly, with proper cuboid size selection, only decompression data for a single cuboid of an input image for each convolution layer are temporarily stored in the HRAM 120 for cuboid convolution while the compressed segments for the other cuboids are still stored in the ZRAM 115. Consequently, the use of external DRAM is eliminated; besides, not only the sizes of the HRAM 120 and the ZRAM 115 but also the size and power consumption of the integrated circuit 100 are reduced.

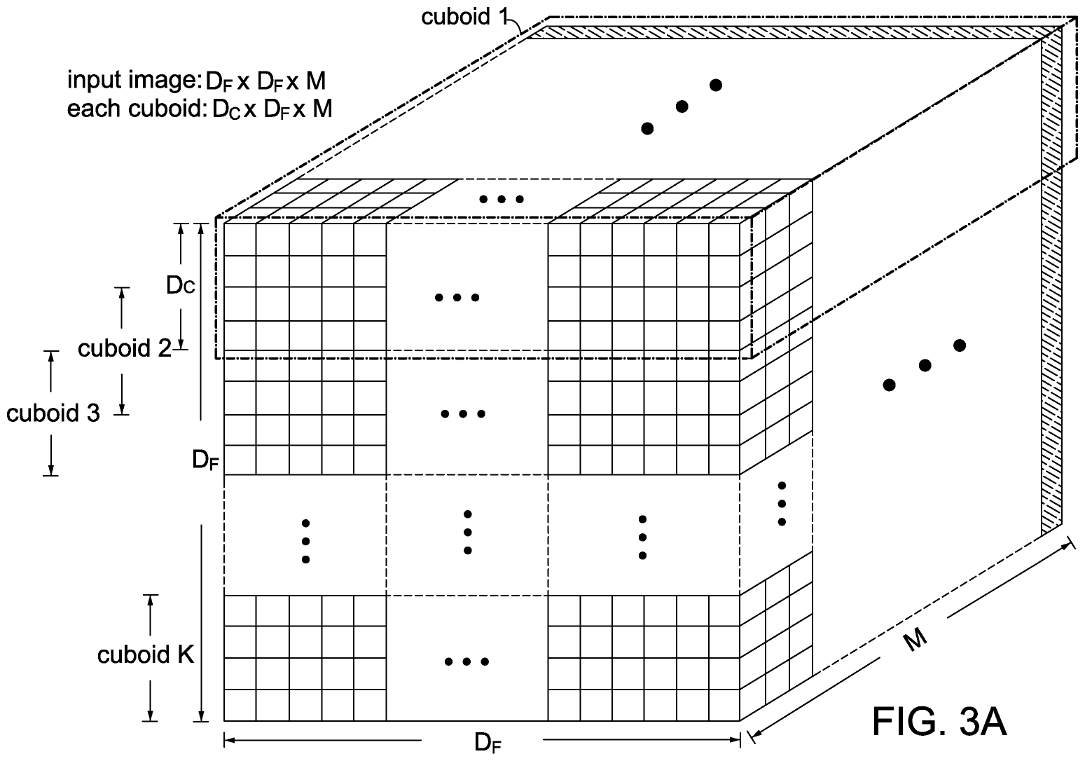

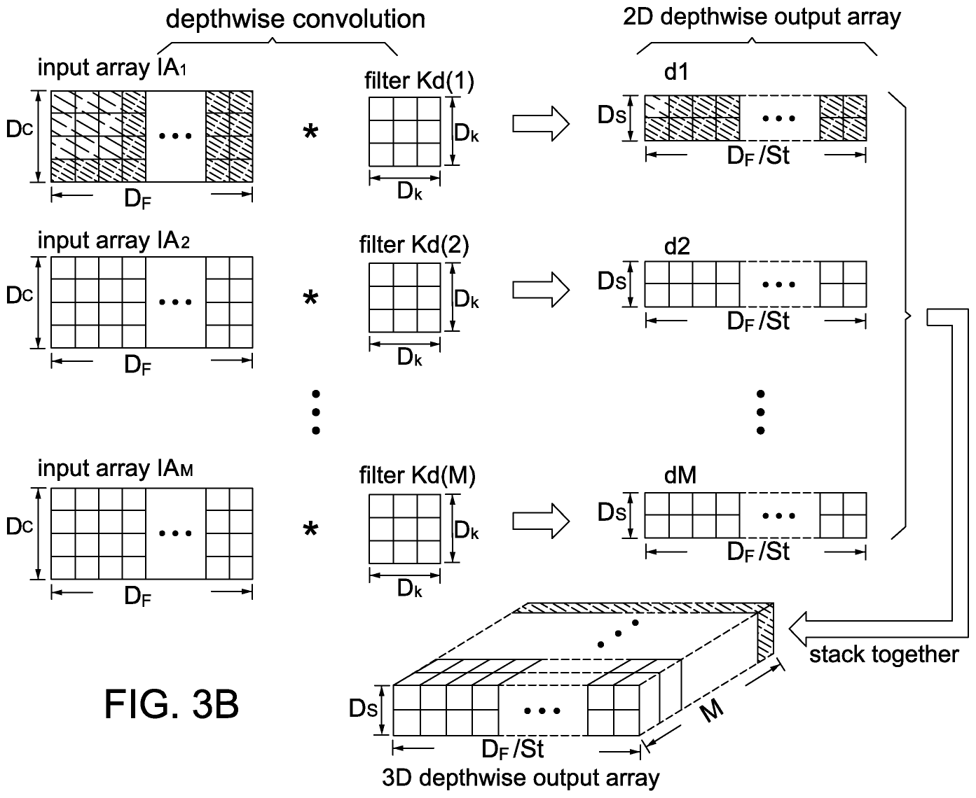

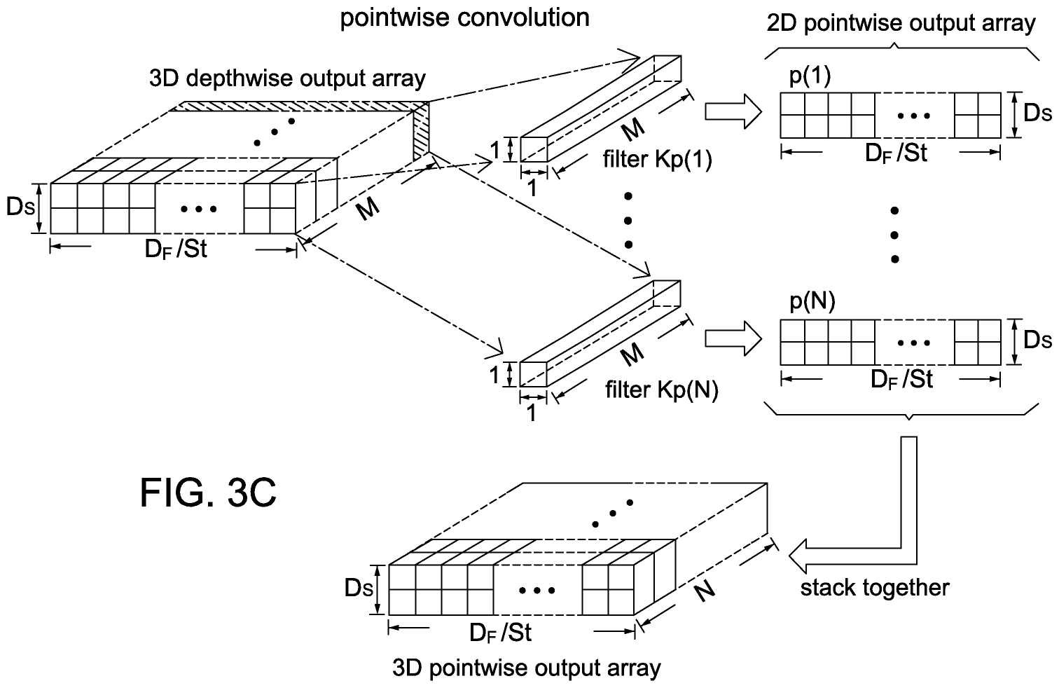

Another feature of the invention is to use the cuboid convolution, instead of conventional depthwise separate convolution, over the de-compressed data with filters to produce a 3D pointwise output array for each cuboid of an input image fed to anyone of the convolution layers of a light weight deep neural network (e.g., MobileNet). The cuboid convolution of the invention is split into a depthwise convolution and a pointwise convolution. Another feature of the invention is to apply a row repetitive value compression (RRVC) scheme to each channel of each cuboid in the output feature map for MobileNet layer 1 and to each 2D pointwise output array (p(1)˜p(N) in FIG. 3C) associated with each cuboid for each convolution layer in MobileNet to generate a compressed segment for each cuboid to be stored in the ZRAM 115.

For purposes of clarity and ease of description, the following embodiments and examples are described in terms of MobileNet (including multiple convolutional layers); however, it should be understood that the invention is not so limited, but is generally applicable to any type of deep neural network that allows to perform the conventional depthwise separate convolution.

Throughout the specification and claims, the following terms take the meanings explicitly associated herein, unless the context clearly dictates otherwise. The term “input image” refers to the total data input fed to either the first layer or each convolution layer of Mobilenet. The term “output feature map” refers to the total data output generated from either the normal/regular convolution for the first layer or the cuboid convolutions of all cuboids for each convolution layer in Mobilenet.

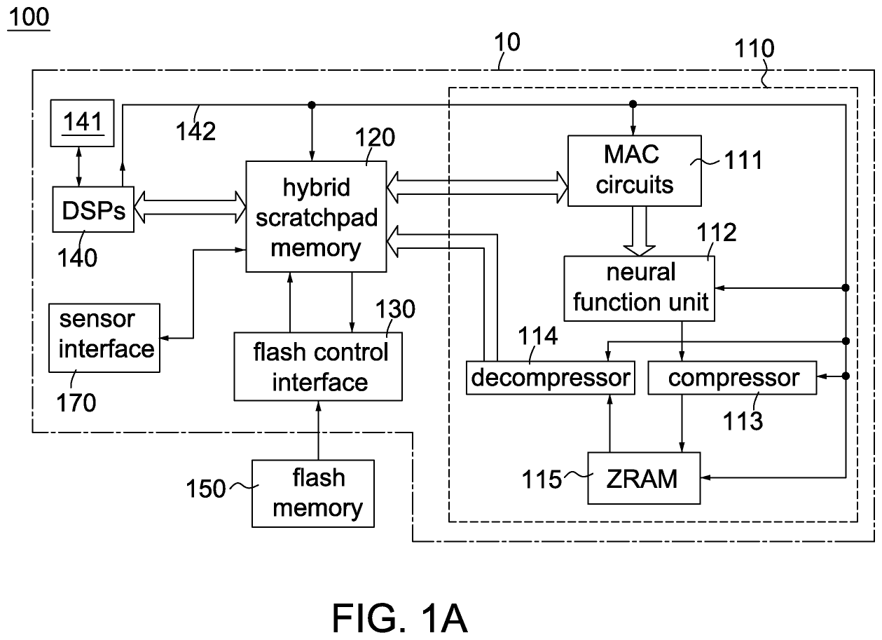

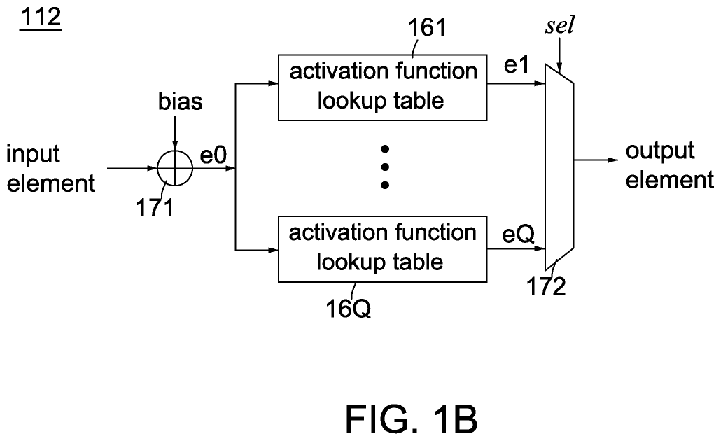

FIG. 1A is a block diagram showing an integrated circuit for convolution calculation according to an embodiment of the invention. Referring to FIG. 1A, an integrated circuit 100 for convolution calculation of the invention, suitable for use in MobileNet, includes a DNN accelerator 110, a hybrid scratchpad memory (hereinafter called “HRAM”) 120, a flash control interface 130, at least one digital signal processor (DSP) 140, a data/program internal memory 141, a flash memory 150 and a sensor interface 170. Here, the DNN accelerator 110, the HRAM 120, the flash control interface 130, the at least one digital signal processor 140, the data/program internal memory 141 and the sensor interface 170 are embedded in a chip 10 while the flash memory 150 is external to the chip 10. The DNN accelerator 110 includes at least one multiply-accumulator (MAC) circuits 111, a neural function unit 112, a compressor 113, a decompressor 114 and a ZRAM 115. The HRAM 120, the data/program internal memory 141 and the ZRAM 115 are internal memories, such as on-chip static RAMs. The numbers of the DSPs 140 and the MAC circuits 111 are varied according to different needs and applications. The DSPs 140 and the MAC circuits 111 operate in parallel. In a preferred embodiment, there are four DSPs 140 and eight MAC circuits 111 in the integrated circuit 100. For ease of description, the following embodiments and examples are described in terms of multiple DSPs 140 and multiple MAC circuits 111. Examples for the sensor interface 170 include, without limitation, a digital video port (DVP) interface. Each of the MAC circuits 111 is well known in the art and normally implemented using a multiplier, an adder and an accumulator. In an embodiment, the integrated circuit 100 is implemented in an edge/mobile device.

According to the programs in the data/program internal memory 141, the DSPs 140 are configured to perform all operations associated with the convolution calculations that includes the regular/normal convolutions and the cuboid convolutions, and to enable/disable the MAC circuits 111, the neural function unit 112, the compressor 113 and the de-compressor 114 via a control bus 142. The DSPs 140 are further configured to control the input/output operations of the HRAM 120 and the ZRAM 115 via the control bus 142. An original input image from an image/sound acquisition device (e.g., a camera) (not shown) are stored into the HRAM 120 via the sensor interface 170. The original input image may be a normal/general image with multiple channels or a spectrogram with a single channel derived from an audio signal (will be described below). The flash memory 150 pre-stores the coefficients forming the filters for layer 1 and each convolution layer in MobileNet. Prior to any convolution calculation for layer 1 and each convolution layer in MobileNet, the DSPs 140 read its corresponding coefficients from the flash memory 150 via the flash control interface 130 and temporarily store them in HRAM 120. During the convolution operation, the DSPs 140 instruct the MAC circuits 111 via the control bus 142 according to the programs in the data/program internal memory 141 to perform related multiplications and accumulations over the image data and coefficients in HRAM 120.

The neural function unit 112 is enabled by the DSP 140 via the control bus 142 to apply a selected activation function over each element from the MAC circuits 111. FIG. 1B is a block diagram showing a neural function unit according to an embodiment of the invention. Referring to FIG. 1B, the neural function unit 112 includes an adder 171, a multiplexer 172 and Q activation function lookup tables 161˜16Q, where Q>=1. There are a large selection of activation functions, e.g., rectified linear unit (ReLU), Tan h, Sigmoid and so on. The number Q and the selection of activation function lookup tables 161˜16Q are varied according to different needs. The adder 171 adds an input element with a bias (e.g., 20) to generate a biased element e0 and then supplies e0 to all the activation function lookup tables 161˜16Q. According to the biased element e0, the activation function lookup tables 161˜16Q respectively output corresponding output values e1˜eQ. Finally, based on the control signal sel, the multiplexer 172 selects one from the output values e1˜eQ to output as an output element.

After the selected activation function is applied to the outputs of the MAC circuits 111, the DSPs 140 instruct the compressor 113 via the control bus 142 to compress data from the neural function unit 112 cuboid by cuboid into multiple compressed segments for multiple cuboids with any compression method, e.g., row repetitive value compression (RRVC) scheme (will be described below). The ZRAM 115 is used to store the compressed segments associated with the output feature map for the first layer and each convolution layer in MobileNet. The decompressor 114 is enabled/instructed by the DSP 140 via the control bus 142 to decompress compressed segments on a compressed segment by compressed segment basis for the following cuboid convolution with any decompression method, e.g., row repetitive value (RRV) decompression scheme (will be described below). The control bus 142 is used to control the operations of the MAC circuits 111, the neural function unit 112, the compressor 113 and the de-compressor 114, the ZRAM 115 and the HRAM 120 by the DSPs 140. In one embodiment, the control bus 142 includes six control lines that originate from the DSPs 140 and are respectively connected to the MAC circuits 111, the neural function unit 112, the compressor 113, the de-compressor 114, the ZRAM 115 and the HRAM 120.

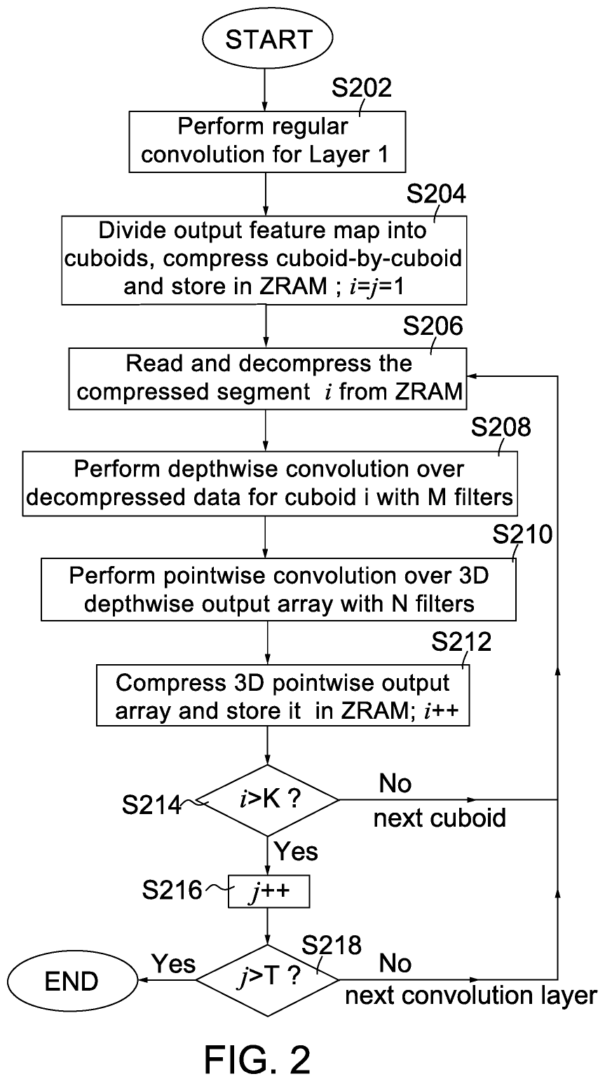

FIG. 2 is a flow chart showing a method for convolution calculation according to an embodiment of the invention. A method for convolution calculation, applied in an integrated circuit comprising a first internal memory and a second internal memory (e.g., the integrated circuit 100 comprising the ZRAM 115 and the HRAM 120) and suitable for use in MobileNet, is described with reference to FIGS. 1A, 2 and 3A-3C. Assuming that (1) there are T convolution layers in MobileNet, (2) an original input image (i.e., an input image fed to layer 1 of MobileNet) is stored into the HRAM 120 in advance and (3) the coefficients (forming corresponding filters) are read from the flash memory 150 into the HRAM 120 in advance for layer 1 and each convolution layer of MobileNet.

Step S202: Perform a regular/standard convolution over the input image using corresponding filters to generate an output feature map. In one embodiment, according to MobileNet spec, apply a regular convolution on the input image in HRAM 120 with corresponding filters to generate the output feature map for layer 1 in MobileNet (which is also an input image for the following convolution layer) by the DSPs 140 and the MAC circuits 111. Here, the input image has at least one channel.

Step S204: Divide the output feature map into multiple cuboids of the same dimension, compress the data for each cuboid into a compressed segment and sequentially store the compressed segments in ZRAM 115. FIG. 3A is an example of an output feature map with a dimension of D_{F}*D_{F}*M for layer 1 in MobileNet. Please note that an output feature map for layer j is equivalent to an input image for layer (j+1) in MobileNet. In one embodiment, referring to FIGS. 3A-3B, the D_{F}*D_{F}*M input image/output feature map is horizontally divided by the DSPs 140 into K cuboids of D_{C}*D_{F}*M, with an overlap of (Dc-Ds) rows for each channel between any two adjacent cuboids. In the example of FIGS. 3A-3C, since Dc=4 and Ds=2, there is an overlap of two rows for each channel between any two adjacent cuboids. Please note that after the cuboid convolution for a previous cuboid is completed, the height of its 3D pointwise output array is only Ds (FIG. 3C). The image data in the last/latter (Dc-Ds) rows of the previous cuboid (FIG. 3A) are still necessary for a next cuboid to perform its cuboid convolution. That's the reason why the overlap of (Dc-Ds) rows for each channel between any two adjacent cuboids is needed in the invention.

Please also note that the data for the M channels of the output feature map for MobileNet layer 1 in FIG. 3A are produced in parallel, from left to right, row-by-row, from top to down. Accordingly, as soon as all the data for cuboid 1 (e.g., from row 1 to row 4 for each channel) are produced in HRAM 120, the DSPs 140 instruct the compressor 113 via the control bus 142 to compress the data for cuboid 1 into a compressed segment 1 with any compression method, e.g., row repetitive value compression (RRVC) method (will be described below), and then store the compressed segment 1 in ZRAM 115. Likewise, as soon as all the data for cuboid 2 (from row 3 to row 6 for each channel) are produced in HRAM 120, the DSPs 140 instruct the compressor 113 to compress the data for cuboid 2 into a compressed segment 2 with RRVC and then store the compressed segment 2 in ZRAM 115. In the same manner, the above compressing and storing operations are repeated until compressed segments corresponding to all the cuboids are stored in ZRAM 115. Please also note that the RRVC method used in steps S204 and S212 are utilized as embodiments and not limitations of the invention. In the actual implementations, any other compression methods can be used and this also falls in the scope of the invention. After compressed segments for all the cuboids of the output feature map for layer 1 are stored in ZRAM 115, the flow proceeds to step S206. At the end of step S204, set i and j to 1.

Step S206: Read the compressed segment i for cuboid i from ZRAM 115 and then de-compress the compressed segment i for the following cuboid convolution in convolution layer j to store its decompression data in HRAM 120. In an embodiment, the DSPs 140 instruct the decompressor 114 via the control bus 142 to read the compressed segments in ZRAM 115 on a compressed segment by compressed segment basis and de-compress the compressed segment i with a decompression method, such as RRV decompression scheme (will be described below), corresponding to the compression method in step S204 to store the decompression data for cuboid i in HRAM 120. Without using any external DRAM, a small storage space of HRAM 120 is sufficient for decompression data of a single cuboid to perform its cuboid convolution operation since the compressed segments for the other cuboids are stored in ZRAM 115 at the same time.

In an alternative embodiment, the regular convolution (steps S202˜S204) and the cuboid convolution operations (steps S206˜S212) are performed in pipelined manner. In other words, performing the cuboid convolution operations (steps S206˜S212) does not need to wait for all the image data of the output feature map for layer 1 in MobileNet to be compressed and stored in ZRAM 115 (steps S202˜S204). Instead, as soon as all the data for cuboid 1 in the output feature map for layer 1 are produced, the DSPs 140 directly perform the cuboid convolution over the data of cuboid 1 for layer 2 (or convolution layer 1) without instructing the compressor 131 to compress the cuboid 1. In the meantime, the compressor 113 proceeds to compress the data of the following cuboids in the output feature map for layer 1 into compressed segments and sequentially store the compressed segments in ZRAM 115 (step S204). After the cuboid convolution associated with cuboid 1 for layer 2 (or convolution layer 1) is completed, the compressed segments of the other cuboids from ZRAM 115 are read on a compressed segment by compressed segment basis and decompressed for cuboid convolution (step S206).

Step S208: Perform depthwise convolution over the decompressed data in HRAM 120 for cuboid i using M filters (Kd(1)˜Kd(M)). According to the invention, the cuboid convolution is a depthwise convolution followed by a pointwise convolution. FIG. 3B is an example showing how the depthwise convolution works. Referring to FIG. 3B, the depthwise convolution is a channel-wise Dₖ*Dₖ spatial convolution. For example, an input array IA₁ of Dc*D_{F} is convoluted with a filter Kd(1) of Dₖ*Dₖ to generate a 2D depthwise output array d1 of Ds*D_{F}/St, an input array IA₂ of Dc*D_{F} is convoluted with a filter Kd(2) of Dₖ*Dₖ to generate a 2D depthwise output array d2 of Ds*D_{F}/St, . . . and so forth. Here, assume all sides of each input array is padded with a layer of zeros (padding=1), then the height Ds=ceil((Dc−2)/St) for 2D depthwise output array, where ceil( ) denotes the ceiling function maps a real number to the least succeeding integer in mathematics and computer science and St denotes a stride that refers to a filter moving over an input array the number of pixels at a time. In MobileNet, St is set to 1 or 2. Since there are M input arrays (equivalent to M channels for cuboid i) in FIG. 3B, there would be a number M of Dₖ*Dₖ spatial convolution to produce a number M of 2D depthwise output arrays (d1˜dM) forming a 3D depthwise output array.

Throughout the specification and claims, the following terms take the meanings explicitly associated herein, unless the context clearly dictates otherwise. The term “input array” refers to a channel of a cuboid in an input image. In the example of FIGS. 3A and 3B, M input arrays (IA₁˜IA_{M}) of Dc*D_{F} form a cuboid of Dc*D_{F}*M; K cuboids of Dc*D_{F}*M correspond to an input image of D_{F}*D_{F}*M, with an overlap of (Dc-Ds) rows for each channel between any two adjacent cuboids. The term “2D pointwise output array” refers to a channel of a 3D pointwise output array associated with a cuboid in a corresponding output feature map. In the example of FIG. 3C, a number N of 2D pointwise output arrays of Ds*(D_{F}/St) form a 3D pointwise output array of Ds*(D_{F}/St)*N associated with a cuboid in a corresponding output feature map and a number K of 3D pointwise output arrays of Ds*(D_{F}/St)*N form the corresponding output feature map of (D_{F}/St)*(D_{F}/St)*N.

Step S210: Perform pointwise convolution over the 3D depthwise output array in HRAM 120 using N filters (Kp(1)˜Kp(N)) to generate a 3D pointwise output array. FIG. 3C is an example showing how the pointwise convolution works. Referring to FIG. 3C, with each of the 1*1*M filters (Kp(1)˜Kp(N)), the DSPs 140 apply the pointwise (or 1*1) convolution across channels of the 3D depthwise output array and combine the corresponding elements of the 3D depthwise output array to produce a value at every position of a corresponding 2D depthwise output array. For example, the 3D depthwise output array of Ds*(D_{F}/St)*M is convoluted with a filter Kp(1) of 1*1*M to generate a 2D pointwise output array p(1) of Ds*(D_{F}/St), the 3D depthwise output array of Ds*(D_{F}/St)*M is convoluted with a filter Kp(2) of 1*1*M to generate a 2D pointwise output array p(2) of Ds*(D_{F}/St), . . . and so forth. After the pointwise convolution, the dimension Ds*(D_{F}/St)*N of the 3D pointwise output array is different from that Ds*(D_{F}/St)*M of the 3D depthwise output array.

Please note that the result of each convolution operation is always applied with a corresponding activation function in the method for convolution calculation of the invention. For purposes of clarity and ease of illustration of the invention, only convolution operations are described and their corresponding activation functions are omitted in FIG. 2. For example, after the regular/standard convolution is performed, an outcome map is produced by the MAC circuits 111 and then a first activation function (e.g., ReLU) would be applied to each element of the outcome map by the neural function unit 112 to produce the output feature map (step S202); after an input array IAₘ of Dc*D_{F} is convoluted with a filter Kd(m) of Dₖ*Dₖ, a depthwise result map is produced by the MAC circuits 111 and then a second activation function (e.g., Tan h) would be applied to each element of the depthwise result map by the neural function unit 112 to produce the 2D depthwise output array dm of Ds*D_{F}/St, where 1<=m<=M (step S208); after a 3D depthwise output array of Ds*(D_{F}/St)*M is convoluted with a filter Kp(n) of 1*1*M, a pointwise result map is produced by the MAC circuits 111 and then a third activation function (e.g., Sigmoid) would be applied to each element of the pointwise result map by the neural function unit 112 to produce the 2D pointwise output array p(n) of Ds*(D_{F}/St), where 1<=n<=N (step S210).

Step S212: Compress the 3D pointwise output array for cuboid i into a compressed segment and store the compressed segment in ZRAM 115. In one embodiment, the DSPs 140 instruct the compressor 113 via the control bus 142 to compress the 3D pointwise output array for cuboid i with RRVC into a compressed segment and store the compressed segment in ZRAM 115. At the end of this step, increase i by one.

Step S214: Determine whether i is greater than K. If Yes, the flow goes to step S216; otherwise, the flow returns to step S206.

Step S216: Increase j by one.

Step S218: Determine whether j is greater than T. If Yes, the flow is terminated; otherwise, the flow returns to step S206.

The method in FIG. 2 applied in an integrated circuit having on-chip RAMs (i.e., HRAM 120 and ZRAM 115) is provided to perform the regular/cuboid convolution calculation for MobileNet and avoid accessing external DRAM for related data. Therefore, in comparison with a conventional integrated circuit for convolution calculation in MobileNet, not only the sizes of HRAM 120 and ZRAM 115 but also the size and power consumption of the integrated circuit 100 are reduced in the invention.

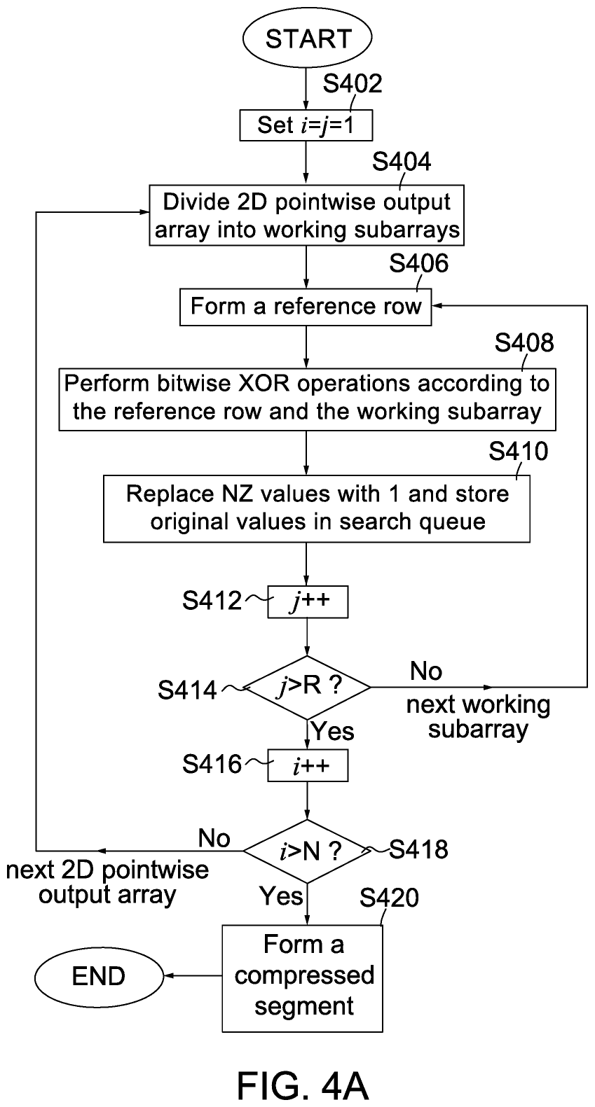

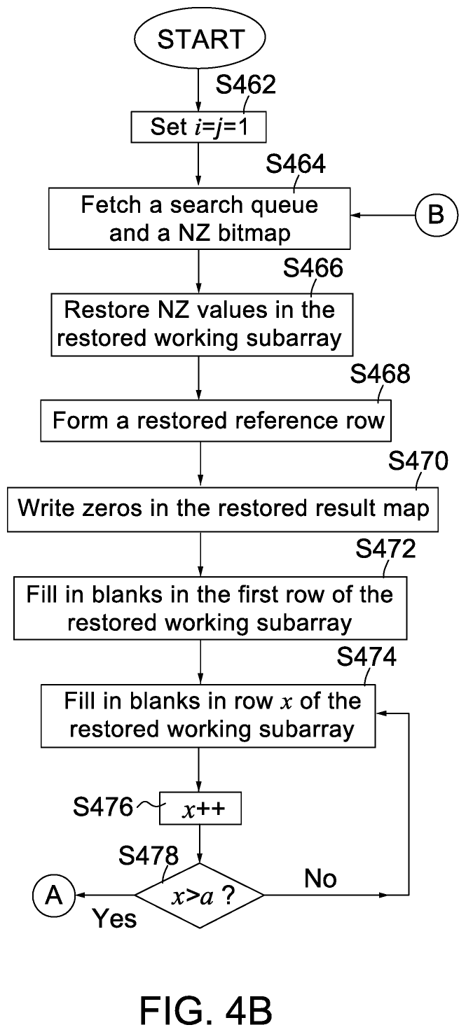

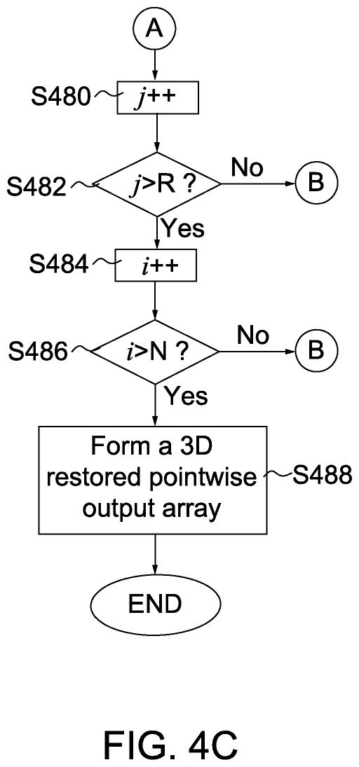

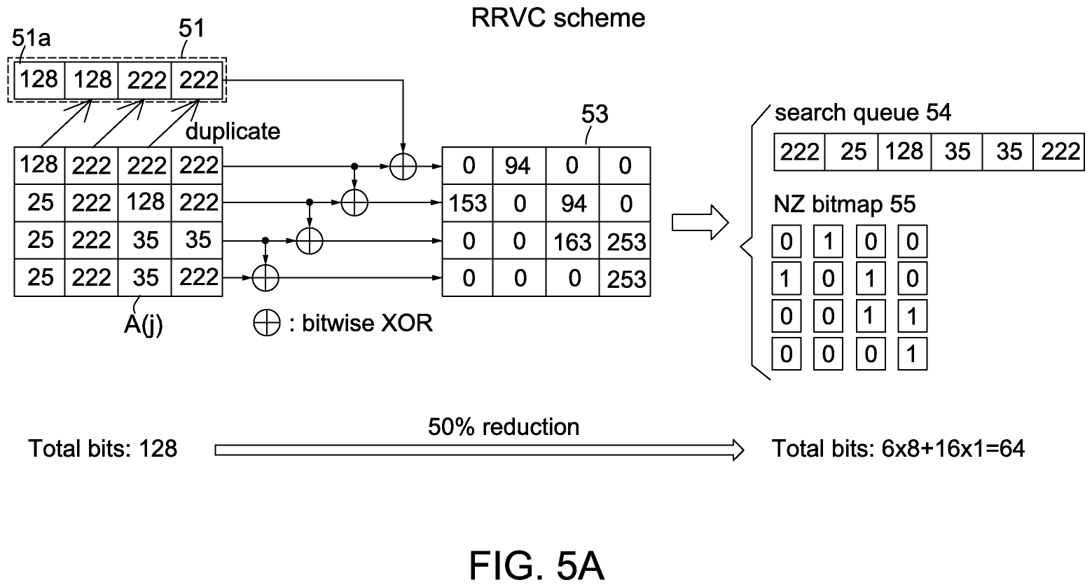

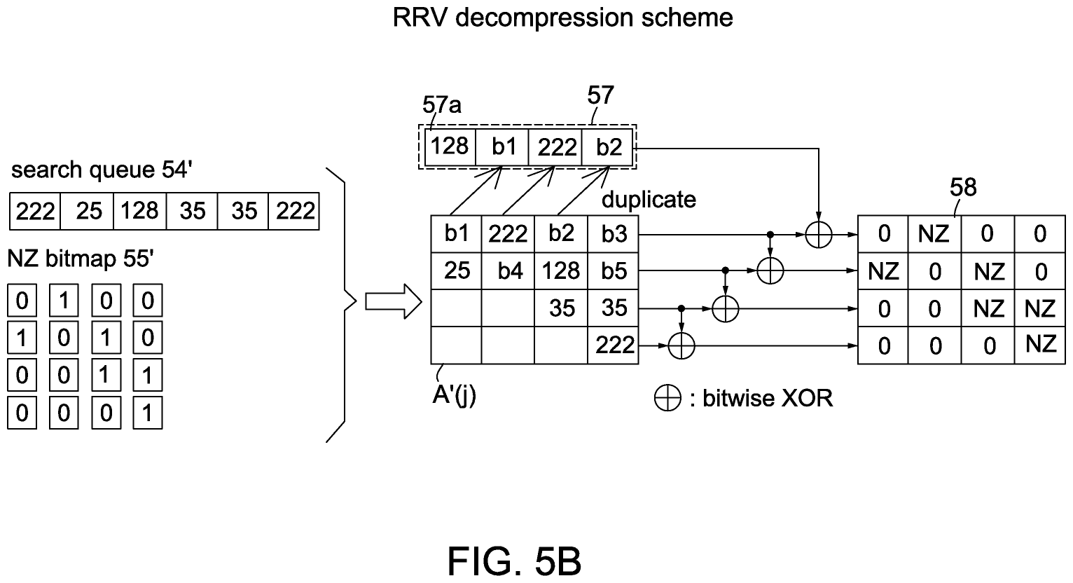

Due to spatial coherence, there exists repetitive value between adjacent rows of either each 2D pointwise output array p(n) for each convolution layer in MobileNet or each channel of each cuboid in the output feature map for layer 1, where 1<=n<=N. Thus, the invention provides the RRVC scheme that mainly performs bitwise XOR operations on adjacent rows of each 2D pointwise output array p(n) or each channel of a target cuboid for reducing the number of bits for storage. FIG. 4A is a flow chart showing a row repetitive value compression (RRVC) scheme according to an embodiment of the invention. FIG. 5A is an example showing how the RRVC scheme works. The compressor 113 applies the RRVC scheme on either each channel of each cuboid in the output feature map for layer 1 in FIG. 3A or each 2D pointwise output array p(n) associated with each cuboid for each convolution layer in FIG. 3C. The RRVC scheme of the invention is described with reference to FIGS. 1A, 3C, 4A and 5A, and with assumption that the RRVC scheme is applied on a 3D pointwise output array having 2D pointwise output arrays (p(1)˜p(N)) for a single cuboid as shown in FIG. 3C.

Step S402: Set parameters i and j to 1 for initialization.

Step S404: Divide a 2D pointwise output array p(i) of a 3D pointwise output array associated with cuboid f into a number R of a*b working subarrays A(j), where R>1, a>1 and b>1. In the example of FIGS. 3A and 5A, a=b=4 and 1<=f<=K.

Step S406: Form a reference row 51 according to a reference phase and the first to the third elements of row 1 of working subarray A(j). In an embodiment, the compressor 113 sets the first element 51a (i.e., reference phase) of the reference row 51 to 128 and copy values of the first to the third elements of row 1 of working subarray A(j) to the second to the fourth elements in the reference row 51.

Step S408: Perform bitwise XOR operations according to the reference row and the working subarray A(j). Specifically, perform bitwise XOR operations on two elements sequentially outputted either from the reference row 51 and the first row of the working subarray A(j) or from any two adjacent rows of the working subarray A(j) to produce corresponding rows of a result map 53. According to the example of FIG. 5A (i.e., a=b=4), perform bitwise XOR operations on two elements sequentially outputted from the reference row 51 and the first row of the working subarray A(j) to generate the first row of the result map 53; perform bitwise XOR operations on two elements sequentially outputted from the first and the second rows of the working subarray A(j) to generate the second row of the result map 53; perform bitwise XOR operations on two elements sequentially outputted from the second and the third rows of the working subarray A(j) to generate the third row of the result map 53; perform bitwise XOR operations on two elements sequentially outputted from the third and the fourth rows of the working subarray A(j) to generate the fourth row of the result map 53.

Step S410: Replace non-zero (NZ) values of the result map 53 with 1 to form a NZ bitmap 55 and sequentially store original values that reside at the same location in the subarray A(j) as the NZ values in the result map 53 into the search queue 54. The original values in the working subarray A(j) are fetched in a top-down and left-right manner and then stored in the search queue 54 by the compressor 113. The search queue 54 and the NZ bitmap 55 associated with the working subarray A(j) are a part of the above-mentioned compressed segment to be stored in ZRAM 115. In the example of FIG. 5A, the total number of bits for storage is reduced from 128 to 64, i.e., compression rate of 50%.

Step S412: Increase j by one.

Step S414: Determine whether j is greater than R. If Yes, the flow goes to step S416; otherwise, the flow returns to step S406 for processing the next working subarray.

Step S416: Increase i by one.

Step S418: Determine whether i is greater than N. If Yes, the flow goes to step S420; otherwise, the flow returns to step S404 for processing the next 2D pointwise output array.

Step S420: Assembly the above NZ maps 55 and search queues 54 into a compressed segment for cuboid f. The flow is terminated.

FIGS. 4B and 4C are flow charts showing a row repetitive value (RRV) decompression scheme according to an embodiment of the invention. FIG. 5B is an example showing how the RRV decompression scheme works. The RRV decompression scheme in FIGS. 4B and C corresponds to the RRVC scheme in FIG. 4A. The decompressor 114 applies the RRV decompression scheme on a compressed segment for a single cuboid. The RRV decompression scheme of the invention is described with reference to FIGS. 1A, 3C, 4B-4C and 5B.

Step S462: Set parameters i and j to 1 for initialization.

Step S464: Fetch a search queue 54′ and a NZ bitmap 55′ from a compressed segment for cuboid f stored in ZRAM 115. The search queue 54′ and the NZ bitmap 55′ correspond to a restored working subarray A′(j) of a 2D restored pointwise output array p′(i) of a 3D restored pointwise output array associated with cuboid f. Assume that the restored working subarray A′(j) has a size of a*b, there are a number R of restored working subarrays A′(j) for each 2D restored pointwise output array p′(i) and there are a number N of 2D restored pointwise output arrays for each 3D restored pointwise output array, where R>1, a>1 and b>1. In the example of FIGS. 3A and 5B, a=b=4 and 1<=f<=K.

Step S466: Restore NZ elements residing at the same location in the restored working subarray A′(j) as the NZ values in the NZ bitmap 55′ according to values in the search queue 54′ and the NZ bitmap 55′. As shown in FIG. 5B, six NZ elements are restored and there are still ten blanks in the restored working subarray A′(j) according to values in the search queue 54′ and the NZ bitmap 55′.

Step S468: Form a restored reference row 57 according to a reference phase and the first to the third elements of row 1 in the restored working subarray A′(j). In an embodiment, the decompressor 114 sets the first element 57a (i.e., reference phase) to 128 and copies values of the first to the third elements of row 1 of the restored working subarray A′(j) to the second to the fourth elements of the restored reference row 57. Assume that b1˜b3 denote blanks in the first row of the restored working subarray A′(j) in FIG. 5B.

Step S470: Write zeros at the same location in the restored result map 58 as the zeros in the NZ bitmap 55′. Set x equal to 2.

Step S472: Fill in blanks in the first row of the restored working subarray A′(j) according to the known elements in the restored reference row 57 and the first row of the restored working subarray A′(j), the zeros in the first row of the restored result map 58 and the bitwise XOR operations over the restored reference row 57 and the first row of A′(j). Thus, we obtain b1=128, b2=222, b3=b2=222 in sequence.

Step S474: Fill in blanks in row x of the restored working subarray A′(j) according to the known elements in row (x−1) and row x of the restored working subarray A′(j), the zeros in row x of the restored result map 58 and the bitwise XOR operations over rows (x−1) and row x of A′(j). For example, if b4˜b5 denote blanks in the second row of the restored working subarray A′(j), we obtain b4=222, b5=b3=222 in sequence.

Step S476: Increase x by one.

Step S478: Determine whether x is greater than a. If Yes, the restored working subarray A′(j) is completed and the flow goes to step S480; otherwise, the flow returns to step S474.

Step S480: Increase j by one.

Step S482: Determine whether j is greater than R. If Yes, the 2D restored pointwise output array p′(i) is completed and the flow goes to step S484; otherwise, the flow returns to step S464.

Step S484: Increase i by one.

Step S486: Determine whether i is greater than N. If Yes, the flow goes to step S488; otherwise, the flow returns to step S464 for the next 2D restored pointwise output array.

Step S488: Form a 3D restored pointwise output array associated with cuboid f according to the 2D restored pointwise output arrays p′(i), where 1<=i<=N. The flow is terminated.

Please note that the working subarrays A(j) in FIG. 5A and the restored working subarray A′(j) in FIG. 5B having a square shape and the sizes of 4*4 are provided by way of example and not limitations of the invention. In actual implementations, the working subarrays A(j) and the restored working subarray A′(j) may have different shapes (i.e., rectangular) and sizes.

As well known in the art, an audio signal can be transformed into a spectrogram by an optical spectrometer, a bank of band-pass filters, Fourier transform or a wavelet transform. The spectrogram is a visual representation of the spectrum of frequencies of the audio signal as it varies with time. Spectrograms are used extensively in the fields of music, sonar, radar, speech processing, seismology, and others. Spectrograms of audio signals can be used to identify spoken words phonetically, and to analyse the various calls of animals. Since the formats of the spectrograms are the same as those of grayscale images, a spectrogram of an audio signal can be regarded as an input image with a single channel in the invention. Thus, the above embodiments and examples are applicable not only to general grayscale/color images, but also to spectrograms of audio signals. As normal grayscale or color images, a spectrogram of an audio signal is transmitted into HRAM 120 via the sensor interface 170 in advance for the above regular convolution and cuboid convolution.

The above embodiments and functional operations in FIGS. 1A-1B, 2 and 4A-4C can be implemented in digital electronic circuitry, in tangibly-embodied computer software or firmware, in computer hardware, including the structures disclosed in this specification and their structural equivalents, or in combinations of one or more of them. The methods and logic flows described in FIGS. 2 and 4A-4C can be performed by one or more programmable computers executing one or more computer programs to perform their functions. The methods and logic flows in FIGS. 2 and 4A-4C, the integrated circuit 100 in FIG. 1A and the neural function unit 112 in FIG. 1B can also be performed by special purpose logic circuitry, e.g., an FPGA (field programmable gate array) or an ASIC (application-specific integrated circuit). Computers suitable for the execution of the one or more computer programs include, by way of example, can be based on general or special purpose microprocessors or both, or any other kind of central processing unit. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

In an alternative embodiment, the DSPs 140, the MAC circuits 111, the neural function unit 112, the compressor 113 and the de-compressor 114 are implemented with a general-purpose processor and a program memory (e.g., the data/program memory 141). The program memory is separate from the HRAM 120 and the ZRAM 115 and stores a processor-executable program. When the processor-executable program is executed by the general-purpose processor, the general-purpose processor is configured to function as: the DSPs 140, the MAC circuits 111, the neural function unit 112, the compressor 113 and the de-compressor 114.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A method applied in an integrated circuit for use in a deep neural network, the integrated circuit comprising a first internal memory and a second internal memory, the method comprising:
(a) decompressing a first compressed segment associated with a current cuboid of a first input image and outputted from the first internal memory to store decompressed data in the second internal memory;
(b) performing cuboid convolution over the decompressed data to generate a 3D pointwise output array;
(c) compressing the 3D pointwise output array into a second compressed segment to store it in the first internal memory;
(d) repeating steps (a) to (c) until all the cuboids associated with a target convolution layer are processed; and
(e) repeating steps (a) to (d) until all of multiple convolution layers are completed;
wherein the first input image is fed to any one of the convolution layers and horizontally divided into a plurality of cuboids of the same dimension, with an overlap of at least one row for each channel between any two adjacent cuboids; and
wherein the cuboid convolution comprises a depthwise convolution followed by a pointwise convolution.

2. The method according to claim 1, further comprising:
applying a regular convolution on a second input image in the second internal memory with first filters for a layer that precedes the convolution layers to generate the first input image prior to steps (a) to (e); and
compressing the first input image into multiple first compressed segments on a cuboid by cuboid basis to store them in the first internal memory after the step of applying and before the steps (a) to (e).

3. The method according to claim 2, wherein the second input image is one of a general image with multiple channels and a spectrogram with a single channel derived from an audio signal.

4. The method according to claim 1, wherein step (b) comprises:
performing the depthwise convolution over the decompressed data with second filters to generate a 3D depthwise output array; and
performing the pointwise convolution over the 3D depthwise output array with third filters to generate the 3D pointwise output array.

5. The method according to claim 1, wherein step (c) further comprises:
(c1) compressing the 3D pointwise output array into the second compressed segment according to a row repetitive value compression (RRVC) scheme.

6. The method according to claim 5, wherein step (c1) further comprises:
(1) dividing a target channel of the 3D pointwise output array into multiple subarrays;
(2) forming a reference row for a target subarray according to a first reference phase and multiple elements in row 1 of the target subarray;
(3) performing bitwise exclusive-OR (XOR) operations to generate a result map based on the reference row and the target subarray;
(4) replacing non-zero (NZ) values in the result map with 1 and fetching their corresponding original values from the target subarray to form a portion of the second compressed segment;
(5) repeating steps (2) to (4) until all the subarrays for the target channel are processed; and
(6) repeating steps (1) to (5) until all the channels of the 3D pointwise output array are processed to form the second compressed segment.

7. The method according to claim 1, wherein step (a) further comprises:
(a1) decompressing the first compressed segment for the current cuboid to generate the decompression data according to a row repetitive value decompression scheme.

8. The method according to claim 7, wherein step (a1) further comprises:
(1) fetching a NZ bitmap and its corresponding original values associated with a target restored subarray of a target channel in the first compressed segment for the current cuboid;
(2) restoring NZ values in the target restored subarray according to the NZ bitmap and its corresponding original values;
(3) forming a restored reference row according to a second reference phase and multiple elements of row 1 in the target restored subarray;
(4) writing zeros in a restored result map according to the locations of zeros in the NZ bitmap;
(5) Fill in blanks row-by-row in the target restored subarray according to known elements in the restored reference row, in the target restored subarray and in the restored result map, the bitwise XOR operations over the target restored reference row and row 1 of the target restored subarray, and the bitwise XOR operations over any two adjacent rows of the target restored subarray;
(6) repeating steps (1) to (5) until all the restored subarrays for the target channel are processed; and
(7) repeating steps (1) to (6) until all the channels for the first compressed segment are processed to form the decompressed data.

9. An integrated circuit applied in a deep neural network, comprising:
at least one processor configured to perform a cuboid convolution over decompression data for each cuboid of a first input image fed to any one of multiple convolution layers;
a first internal memory coupled to the at least one processor;
at least one multiply-accumulator (MAC) circuit coupled to the at least one processor and the first internal memory for performing multiplication and accumulation operations associated with the cuboid convolution to output a first convoluted cuboid;
a second internal memory for storing multiple compressed segments only;
a compressor coupled to the at least one processor, the at least one MAC circuit and the first and the second internal memories and configured to compress the first convoluted cuboid into one compressed segment to store it in the second internal memory; and
a decompressor coupled to the at least one processor, the first and the second internal memories and configured to decompress the compressed segments from the second internal memory on a compressed segment by compressed segment basis to store the decompression data for a single cuboid in the first internal memory;
wherein the first input image is horizontally divided into a plurality of cuboids of the same dimension, with an overlap of at least one row for each channel between any two adjacent cuboids; and
wherein the cuboid convolution comprises a depthwise convolution followed by a pointwise convolution.

10. The integrated circuit according to claim 9, wherein the at least one processor is further configured to perform a regular convolution over a second input image with first filters for a layer that precedes the convolution layers and cause the at least one MAC circuit to generate the first input image having multiple second convoluted cuboids, and wherein the first internal memory is used to store the second input image.

11. The integrated circuit according to claim 10, wherein the second input image is one of a general image with multiple channels and a spectrogram with a single channel derived from an audio signal.

12. The integrated circuit according to claim 10, wherein the at least one processor is further configured to perform the depthwise convolution over the decompressed data with second filters and cause the at least one MAC circuit to generate a 3D depthwise output array, and then perform the pointwise convolution over the 3D depthwise output array with third filters and cause the at least one MAC circuit to generate the first convoluted cuboid.

13. The integrated circuit according to claim 12, further comprising:
a flash memory for pre-storing coefficients forming the first, the second and the third filters;
wherein the at least one processor is further configured to read corresponding coefficients from the flash memory and temporarily store them in the first internal memory prior to the regular convolution and the cuboid convolution.

14. The integrated circuit according to claim 10, wherein the compressor is further configured to compress each of the first and the second convoluted cuboids as a target cuboid to generate a corresponding compressed segment according to a row repetitive value compression (RRVC) scheme.

15. The integrated circuit according to claim 14, wherein according to the RRVC scheme, the compressor is further configured to
(1) divide a target channel of the target cuboid into multiple subarrays;
(2) form a reference row for a target subarray according to a first reference phase and multiple elements in row 1 of the target subarray;
(3) perform bitwise exclusive-OR (XOR) operations to generate a result map based on the reference row and the target subarray;
(4) replace non-zero values in the result map with 1 and fetching their corresponding original values from the target subarray to form a portion of the corresponding compressed segment;
(5) repeat steps (2) to (4) until all the subarrays for the target channel are processed; and
(6) repeat steps (1) to (5) until all the channels of the target cuboid are processed to form the corresponding compressed segment.

16. The integrated circuit according to claim 9, wherein the decompressor is further configured to decompress each compressed segment from the second internal memory according to a row repetitive value decompression scheme.

17. The integrated circuit according to claim 16, wherein according to the row repetitive value decompression scheme, the decompressor is further configured to:
(1) fetch a non-zero (NZ) bitmap and its corresponding original values associated with a target restored subarray of a target channel in one compressed segment for a target cuboid;
(2) restore NZ values in the target restored subarray according to its corresponding original values;
(3) form a restored reference row according to a second reference phase and multiple elements of row 1 in the target restored subarray;
(4) write zeros in a restored result map according to the locations of zeros in the NZ bitmap;
(5) Fill in blanks row-by-row in the target restored subarray according to known elements in the restored reference row, in the target restored subarray and in the restored result map, the bitwise XOR operations over the restored reference row and row 1 of the target restored subarray, and the bitwise XOR operations over any two adjacent rows of the target restored subarray;
(6) repeat steps (1) to (5) until all the restored subarrays for the target channel are processed; and
(7) repeat steps (1) to (6) until all the channels of the compressed segment for the target cuboid are processed to form the decompressed data.

18. The integrated circuit according to claim 9, further comprising:
a neural function unit coupled among the at least one processor, the at least one MAC circuit and the compressor and configured to apply a selected activation function to each element outputted from the at least MAC circuit.

19. The integrated circuit according to claim 18, wherein the neural function unit comprises:
an adder for adding each element from the at least MAC circuit with a bias value to generate a biased element;
a number Q of activation function lookup tables coupled to the adder for outputting Q activation values according to the biased element; and
a multiplexer coupled to the compressor and the output terminals of the number Q of activation function lookup tables for selecting one of the Q activation values as an output element.
